(19) United States
(12) Patent Application Publication
(10) Pub. No.: US 2006/0273981 A1
(43) Pub. Date: Dec. 7, 2006

(54) Antenna attachment arrangement

(76) Inventors: Loren M. Thompson, Lapeer, MI (US); Edward Menassaka, Grand Blanc, MI (US); Steven V. Byrne, Burton, MI (US); Randall J. Heidtman, Columbiaville, MI (US); Richard J. Lawrence, Goodrich, MI (US); William R. Livengood, Grand Blanc, MI (US)

Correspondence Address: DELPHI TECHNOLOGIES, INC., M/C 480-410-202, PO BOX 5052, TROY, MI, 48007, US

(21) Appl. No.: 11/145,709

(22) Filed: Jun. 6, 2005

(51) Int. Cl. H01Q 1/50

(52) U.S. Cl. 343/906; 343/713

(57) ABSTRACT

An antenna module for a vehicle communication system can be attached to a vehicle using an attachment arrangement that includes a cast and a single module that incorporates a bolt with an integrated retainer clip. The attachment arrangement acts as its own snap. The retainer clip has a spring mechanism. The installer installs the attachment arrangement to a through hole, for example, in a vehicle roof panel. As the retainer clip passes through the through hole, it collapses around the body of the cast. After the retainer clip passes completely through the through hole, the spring mechanism causes the retainer clip to rebound back to its original span to temporarily hold the antenna module in place. The installer then tightens the bolt, thereby stroking the integrated retainer clip up the cast toward the vehicle roof panel. When the retainer clip contacts the vehicle roof panel, the installer further tightens the bolt to a recommended drive torque. This further tightening of the bolt creates a clamp load between the antenna module and the vehicle roof panel to provide a robust joint and watertight seal for the life of the vehicle.

### TECHNICAL BACKGROUND

The present invention relates generally to antenna systems. More particularly, the present invention relates to attachment of antenna systems to vehicles.

### BACKGROUND OF THE INVENTION

The vast majority of vehicles currently in use incorporate vehicle communication systems for receiving or transmitting signals. For example, vehicle audio systems provide information and entertainment to many motorists daily. These audio systems typically include an AM/FM radio receiver and receive radio signals via an antenna. The antenna may be attached to the vehicle in a number of ways. For instance, in some vehicles, the antenna is mounted on a glass surface, such as a windshield or rear window. In other vehicles, the antenna is mounted on a metal surface, e.g., the roof of the vehicle.

Industry-wide vehicle manufacturing standards require that exterior mounted antenna modules incorporate a type of attachment mechanism, known as an all-inclusive fastening system, to secure the antenna module to a vehicle panel, e.g., a vehicle roof panel. These standards require that the fastening system be entirely contained within the antenna module. Further, the fastening system must allow an installer to hand-place the antenna module and its associated cables to the vehicle panel temporarily. Accordingly, the fastening system should have a low insertion force to promote assembly ergonomics and a high extraction force to prevent the fastening system from accidentally falling out of the vehicle panel. With the antenna module and cables thus temporarily fastened to the vehicle panel, the installer enables a permanent, high clamp load fastening mechanism in order to provide a robust joint and watertight seal for the life of the vehicle.

One conventional type of all-inclusive fastening system incorporates a number of distinct components, including a cast, a plastic snap, a plastic retaining clip, and an M6-type bolt. This type of system is passed through a hole in the vehicle roof panel. The majority of the fastening system has a smaller diameter than the hole and, accordingly, passes through the hole without resistance. The plastic snap, however, has a larger diameter than the hole and engages the underside of the vehicle roof panel. As a result, the antenna module is temporarily attached to the vehicle panel.

Once the antenna module is thus secured to the vehicle panel, the installer drives the M6-type bolt. This action causes the M6-type bolt to stroke the metal retaining clip up the cast. Using the cast as an anvil, the metal retaining clip balloons outward until the metal retaining clip contacts the vehicle roof panel. In particular, finger-like structures disposed around the metal retaining clip balloon outward beyond the diameter of the hole in the vehicle roof panel. As the metal retaining clip balloons outward in this way, it undergoes severe plastic deformation. Accordingly, each metal retaining clip can only be used for a single installation cycle.

After the metal retaining clip contacts the vehicle roof panel, the installer continues to tighten the M6-type bolt to a drive torque recommended, for example, by manufacturer specifications. Tightening the M6-type bolt to the recommended drive torque provides a clamp load between the antenna module and the vehicle roof panel. The clamp load provides a robust joint and watertight seal that is intended to last for the useful life of the vehicle.

This type of all-inclusive fastening mechanism can both temporarily attach the antenna module and associated cables to the vehicle roof panel and facilitate a more permanent attachment at the appropriate stage in the manufacturing process. As described above, however, the metal retaining clip undergoes severe plastic deformation and, consequently, can only be used for a single installation cycle.

Further, each plastic snap is designed to engage the underside of a vehicle roof panel of a specific thickness, e.g., 1 mm. To attach an antenna module to a vehicle roof panel having a different thickness, e.g., 3 mm, a different plastic snap designed to engage the underside of a vehicle roof panel of that thickness must be retooled.

### SUMMARY OF THE INVENTION

In various embodiments of the present invention, an installer attaches an antenna module for a vehicle communication system to a vehicle using an attachment arrangement that includes a cast within a single module that incorporates a bolt with an integrated retainer clip. The module acts as its own snap. The retainer clip has a spring mechanism. The installer installs the attachment arrangement to a through hole, for example, in a vehicle roof panel. As the retainer clip passes through the through hole, it collapses around the body of the cast. After the retainer clip passes completely through the through hole, the spring attribute causes the retainer clip to rebound back to its original span to temporarily hold the antenna module in place. The installer then tightens the bolt, thereby stroking the integrated retainer clip up the cast toward the vehicle roof panel. When the retainer clip contacts the vehicle roof panel, the installer further tightens the bolt to a recommended drive torque. This further tightening of the bolt creates a clamp load between the antenna module and the vehicle roof panel to provide a robust joint and watertight seal for the life of the vehicle.

According to an example embodiment of the present invention, an attachment arrangement for securing a module to a vehicle component defining an aperture includes a cast and a clip. The clip has flanges that compress when the clip is inserted in the aperture. The flanges expand after the clip is fully inserted in the aperture. A bolt is coupled to the clip and to the cast. The bolt drives the clip toward an end of the cast when the bolt is tightened.

In specific implementations, the clip may have dogleg-type projections to prevent the clip from rotating during installation. Further, the attachment arrangement may be arranged to receive electrical interconnects. In some implementations, the attachment arrangement is used to secure an antenna module to a vehicle panel, such as a vehicle roof panel.

Another embodiment is directed to a method to attach a module to a vehicle component defining an aperture. An attachment arrangement is inserted through the aperture. The attachment arrangement has a clip with flanges that compress when the clip is inserted in the aperture. The clip is fully inserted in the aperture. As a result, the flanges secure the attachment arrangement to the vehicle component. The clip is then driven toward the vehicle component, e.g., by driving a bolt, and the module is installed to the attachment arrangement. The bolt may be tightened to a recommended drive torque to establish a secure fit between the attachment arrangement and the vehicle component.

Various embodiments of the present invention may provide certain advantages relative to some conventional antenna attachment arrangements. Because the attachment arrangement acts as its own snap, the need for a separate snap is obviated. Moreover, the deformable plastic retaining clip characteristic of some conventional arrangements can be omitted to reduce the number of mechanical components involved in attaching the antenna module and simplify the manufacturing process. Costs associated with tooling the plastic retaining clip may also be eliminated. The cost and complexity of the tools used in manufacturing the cast may also be reduced.

Further, the antenna attachment arrangement of the present invention can be tuned for a variety of vehicle panel thicknesses for different materials, e.g., sheet metal or a composite material. In addition, the clip does not deform and thus can be used over multiple installation cycles. An antenna module or other component can be serviced more easily as a result. In particular, the clip can be reused rather than replaced after servicing is complete.

Additional objects, advantages, and features of the present invention will become apparent from the following description and the claims that follow, considered in conjunction with the accompanying drawings.

### BRIEF DESCRIPTION OF THE DRAWINGS

The present invention will now be described, by way of example, with reference to the accompanying drawings, in which:

FIG. 1 illustrates an example antenna attachment arrangement for attaching an antenna module to a vehicle according to an embodiment of the invention;

FIG. 2 is a profile view illustrating an example bolt/clip arrangement for use in connection with the antenna attachment arrangement of FIG. 1, according to another embodiment of the invention;

FIG. 3 is a plan view of the bolt/clip arrangement depicted in FIG. 2;

FIG. 4 is an isometric view of the bolt/clip arrangement depicted in FIG. 2; and

FIG. 5 is a flow diagram illustrating an example method for installing an antenna module to a vehicle according to another embodiment of the invention.

### DESCRIPTION OF PREFERRED EMBODIMENTS

Various embodiments of the present invention facilitate installing an antenna module on a vehicle using an assembly that includes a bolt with an integrated retainer clip that are incorporated into a single unit and a cast. The retainer clip is a spring mechanism. The assembly is installed to a through hole, for example, in a vehicle roof panel. As the retainer clip passes through the through hole, it collapses around the body of the cast. After the retainer clip passes completely through the through hole, the spring mechanism causes the retainer clip to rebound back to its original span to temporarily hold the antenna module in place. The assembly acts as its own snap, obviating the need for a separate snap. The installer then tightens the bolt, thereby stroking the integrated retainer clip up the cast toward the vehicle roof panel. When the retainer clip contacts the vehicle roof panel, the installer further tightens the bolt to a recommended drive torque. This further tightening of the bolt creates a clamp load between the antenna module and the vehicle roof panel to provide a robust joint and watertight seal for the life of the vehicle.

The following description of various embodiments directed to a vehicle audio system is to be construed by way of illustration rather than limitation. This description is not intended to limit the invention or its applications or uses. For example, while various embodiments of the invention are described as facilitating attachment of an antenna module for use in connection with a vehicle communication system, it will be appreciated that the principles of the invention are applicable to other systems in a vehicle in which a component is attached to an exterior surface of the vehicle.

In the following description, numerous specific details are set forth in order to provide a thorough understanding of various embodiments of the present invention. It will be apparent to one skilled in the art that the present invention may be practiced without some or all of these specific details. In other instances, well known process steps have not been described in detail in order to avoid unnecessarily obscuring the present invention.

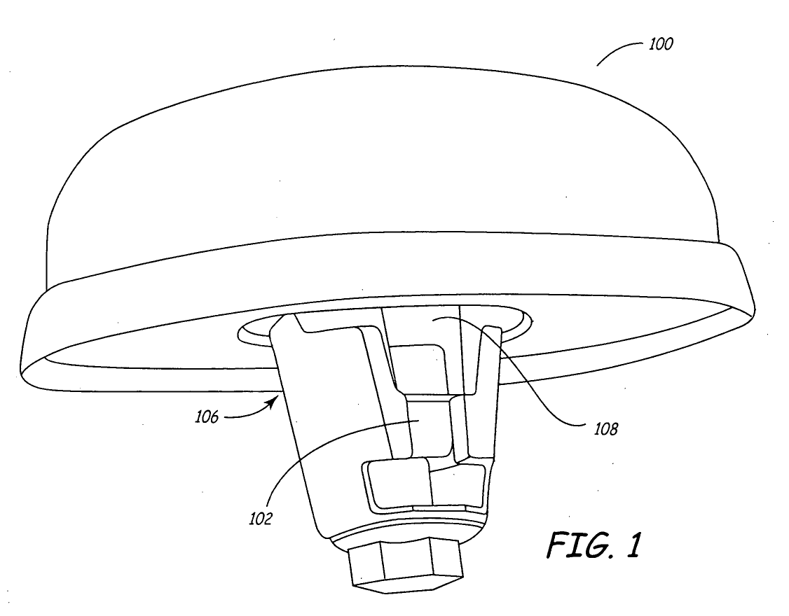

Referring now to the drawings, FIG. 1 illustrates an example antenna attachment arrangement 100 for attaching an antenna module to a vehicle, for example, to a vehicle roof panel. A cast 102 is passed through a through hole in the vehicle roof panel. The cast 102 has a smaller diameter than the through hole and therefore passes through the through hole without resistance from the vehicle roof panel. A portion 104 of the cast 102 has a larger diameter than the through hole. After the cast 102 has passed through the through hole, the antenna attachment arrangement 100 engages an underside of the vehicle roof panel thickness and temporarily attaches the antenna module to the vehicle. This temporary attachment is accomplished with a low insertion force so that the installer can easily establish it. However, the temporary attachment has a high extraction force, decreasing the likelihood that the antenna module would accidentally fall out.

The cast 102 receives a bolt/clip arrangement 106 that, when installed to the vehicle roof panel through hole with the cast 102, collapses about the cast 102. The cast 102 may receive the bolt/clip arrangement 106 in any of a variety of ways, including, but not limited to, cooperating threads on the cast 102 and the bolt/clip arrangement 106. Once the bolt/clip arrangement 106 passes through the vehicle roof panel, the clip rebounds back to its maximum span to temporarily secure the antenna module. The installer then tightens the bolt, thereby stroking the clip up the cast 102. When the clip contacts the vehicle roof panel, the installer tightens the bolt to the recommended drive torque. In this way, a clamp load is provided between the antenna module and the vehicle roof panel to establish a robust joint and watertight seal for the life of the vehicle. The cast 102 defines a connector receptacle 108 through which the installer can pass electrical interconnects, such as cables while the clip is installed to the vehicle panel through hole. In this way, installation of the antenna module is significantly facilitated.

With the antenna module secured by a spring mechanism, the need for a deformable plastic retaining clip and a separate snap is obviated. As a result, the manufacturing process is simplified by the reduction in mechanical components involved in attaching the antenna module, i.e., the cast, the bolt, and the retaining clip integrated with the bolt into a single assembly. Because a plastic retaining clip need not be manufactured, the costs associated with tooling the plastic retaining clip may be eliminated. The cost and complexity of the tools used in manufacturing the cast may also be reduced.

Further, the bolt/clip arrangement 106 is more versatile than the deformable metal retaining clip used in some conventional all-inclusive fastening mechanisms. In particular, the bolt/clip arrangement 106 can be tuned for a variety of vehicle panel thicknesses, e.g., 1 mm for sheet metal and 3 mm for a composite material. By contrast, some conventional all-inclusive fastening mechanisms require tooling of a new plastic snap to allow retention to different vehicle panel thicknesses. Different plastic snap designs must be used, for example, to allow retention to 1 mm sheet metal vehicle panels and 3 mm composite vehicle panels.

Because the bolt/clip arrangement 106 does not undergo plastic deformation, the clip can be used over multiple installation cycles. A service technician can remove the clip, for example, to service the antenna module, and replace the clip when servicing has been completed. As a result, serviceability is enhanced. By contrast, because the metal retaining clip used in some conventional all-inclusive fastening mechanisms undergoes severe plastic deformation during the initial installation, a particular metal retaining clip can only be used once. If the plastic retaining clip needs to be removed, it must be replaced with a new plastic retaining clip.

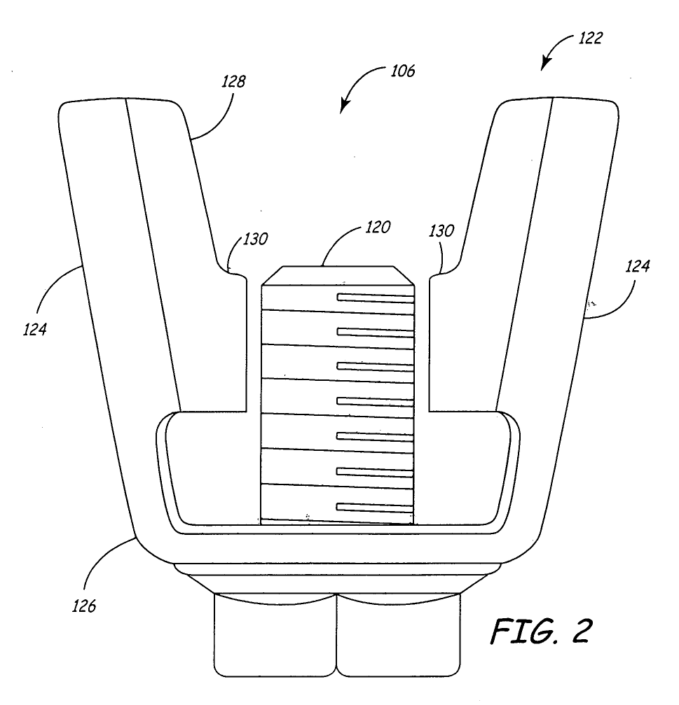

FIG. 2 is a profile view illustrating an example implementation of the bolt/clip arrangement 106. The bolt/clip arrangement 106 includes a bolt 120 and a clip 122. The bolt 120 may be implemented using any of a variety of conventional bolts, including, for example, an M6-type bolt. The bolt 120 preferably has threads that cooperate with corresponding threads on the cast 102, such that the cast 102 can receive the bolt 120. The clip 122 has flanges 124 formed of a flexible material, such as steel, that implement a spring mechanism that enables the clip 122 to collapse and expand to fill the space that the clip 122 occupies. As shown in FIG. 2, the clip 122 has a smaller diameter at an end 126 relative to its diameter at another end 128. Due to this increase in diameter from the end 126 to the end 128, as the bolt/clip arrangement 106 is installed to the vehicle roof panel through hole, the vehicle roof panel applies a force to the flanges 124. The clip 122 collapses about the cast 102 as a result. Once the clip 122 passes through the vehicle roof panel, the vehicle roof panel no longer applies the force to the flanges 124, and the clip 122 rebounds back to its maximum span to temporarily secure the antenna module.

As shown in FIG. 2, the flanges 124 preferably have dogleg-type projections 130. These projections 130 interface with flat features on the cast 102. In this way, the projections 130 prevent the clip 122 from rotating inappropriately when the clip 122 is stroked up the cast 102 by tightening the bolt 120. Further, the projections 130 ensure that the clip 122 does not overextend its body when the bolt 120 is tightened. In addition, when the bolt 120 is tightened, the projections 130 support lateral loads on the clip 122.

After the clip 122 has passed through the vehicle roof panel and rebounded to its maximum span, the installer tightens the bolt 120, thereby stroking the clip 122 up the cast 102. When the clip contacts the vehicle roof panel, the installer tightens the bolt 120 to the recommended drive torque. In this way, a clamp load is provided between the antenna module and the vehicle roof panel to establish a robust joint and watertight seal for the life of the vehicle.

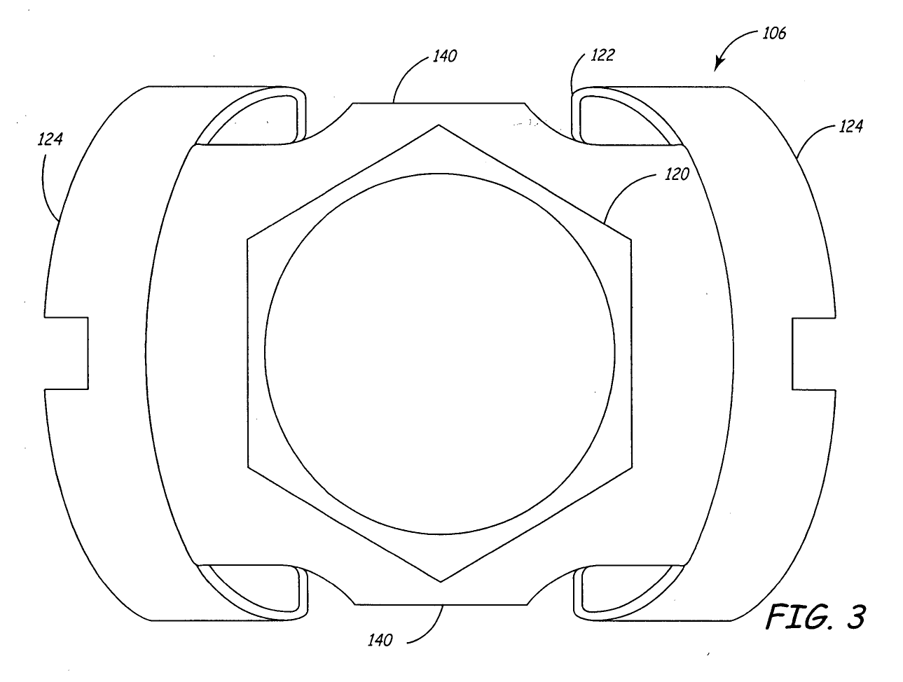

FIG. 3 is a plan view of the bolt/clip arrangement 106 shown in FIG. 2. As illustrated in FIG. 3, the clip 122 is preferably elongated along one axis of its footprint, e.g., an axis coplanar with the flanges 124. For example, as the clip 122 is installed to the vehicle panel through hole, the flanges 124 are compressed to fill the diameter of the through hole. By contrast, another axis of the footprint of the clip 122, e.g., an axis collinear with portions 140 of the clip 122 that do not have flanges 124, has a length less than the diameter of the through hole.

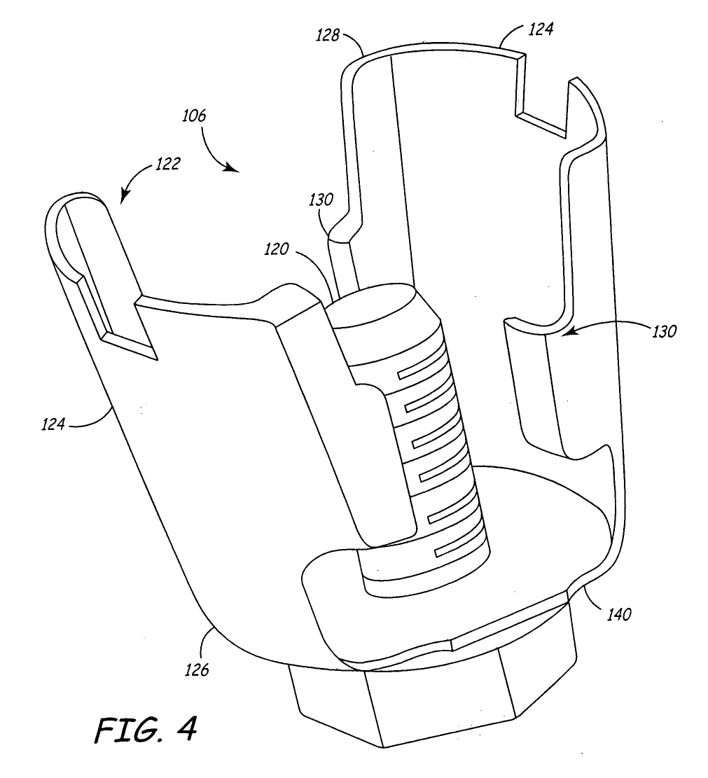

FIG. 4 is an isometric view of the bolt/clip arrangement 106 depicted in FIG. 2. As shown in FIG. 4, each flange 124 may have dogleg-type projections 130 on both sides to prevent the clip 122 from rotating when the installer tightens the bolt 120 and strokes the clip 122 up the cast 102. The projections 130 also support lateral loads on the clip 122 and ensure that the clip 122 does not overextend its body when the installer tightens the bolt 120. While the flanges 124 are depicted in FIG. 4 as each having two dogleg-type projections 130, the invention is not so limited. For example, one or both flanges 124 may only have one such projection 130. As another alternative, one or both flanges 124 may lack the projections 130 altogether.

Those skilled in the art will appreciate that the implementation illustrated in FIG. 4 is merely one example implementation. The spirit and scope of the invention include other configurations of the clip 122. In an alternative implementation, for example, the clip 122 may have four flanges 124 disposed around its perimeter. This alternative implementation may provide a more secure fit as the clip 122 is installed to the vehicle panel through hole.

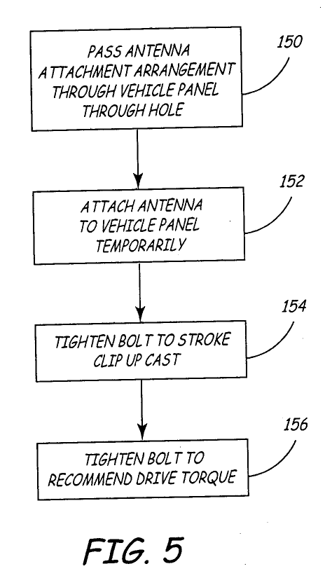

FIG. 5 is a flow diagram illustrating an example method for installing an antenna module to a vehicle according to another embodiment of the invention. The installer passes the antenna attachment arrangement 100 through a vehicle panel roof hole (150). Because most of the antenna attachment arrangement 100 has a smaller diameter than the through hole, it passes partially through the through hole without resistance from the vehicle roof panel. As the antenna attachment arrangement 100 passes through the through hole, the clip 122 collapses about the cast 102. When the antenna attachment arrangement 100 engages the underside of the vehicle panel, the antenna module is temporarily attached to the vehicle panel (152). This temporary attachment is accomplished with a low insertion force so that the installer can easily establish it. However, the temporary attachment has a high extraction force, decreasing the likelihood that the antenna module would accidentally fall out.

Once the bolt/clip arrangement 106 passes through the vehicle roof panel, the clip 122 rebounds back to its maximum span to temporarily secure the antenna module. The installer then tightens the bolt 120, thereby stroking (154) the clip 122 up the cast 102. When the clip 122 contacts the vehicle roof panel, the installer tightens the bolt 120 to the recommended drive torque (156). Tightening the bolt 120 to the recommended drive torque creates a clamp load between the antenna module and the vehicle roof panel. As a result, a robust joint and watertight seal are established for the life of the vehicle.

As demonstrated by the foregoing discussion, various embodiments of the present invention may offer a number of benefits relative to some conventional antenna attachment arrangements. For example, the deformable metal retaining clip characteristic of some conventional arrangements can be omitted. This omission of the separate snap and the metal retaining clip reduces the number of mechanical components involved in attaching the antenna module, thereby simplifying the manufacturing process. Costs associated with tooling the snap and plastic retaining clip are also eliminated. The cost and complexity of the tools used in manufacturing the cast may also be reduced.

Further, the antenna attachment arrangement of the present invention can be tuned for a variety of vehicle panel thicknesses for different materials, e.g., sheet metal or a composite material. In addition, the clip does not deform and thus can be used over multiple installation cycles. Serviceability is enhanced as a result.

It will be understood by those who practice the invention and those skilled in the art that various modifications and improvements may be made to the invention without departing from the spirit and scope of the disclosed embodiments. The scope of protection afforded is to be determined solely by the claims and by the breadth of interpretation allowed by law.

What is claimed is:

1. An attachment arrangement for securing a module to a vehicle component defining an aperture, the attachment arrangement comprising:
a cast;
a clip having a plurality of flanges configured to compress when the clip is inserted in the aperture, the flanges further configured to expand after the clip is fully inserted in the aperture; and
a bolt coupled to the clip and to the cast and configured to drive the clip toward an end of the cast when the bolt is tightened.

2. The attachment arrangement of claim 1, wherein at least one flange comprises a dogleg-type projection configured to engage with a flat feature of the cast.

3. The attachment arrangement of claim 1, wherein the cast defines a connector receptacle configured to receive an electrical interconnect.

4. The attachment arrangement of claim 1, wherein a length of the clip along one axis is smaller than a diameter of the aperture.

5. The attachment arrangement of claim 1, wherein the module comprises an antenna module.

6. The attachment arrangement of claim 1, wherein the vehicle component comprises a vehicle panel.

7. The attachment arrangement of claim 6, wherein the vehicle panel comprises a vehicle roof panel.

8. A method to attach a module to a vehicle component defining an aperture, the method comprising:
inserting an attachment arrangement through the aperture, the attachment arrangement having a clip having a plurality of flanges configured to compress when the clip is inserted in the aperture;
inserting the clip fully in the aperture, thereby causing the flanges to secure the attachment arrangement to the vehicle component;
driving the clip toward the vehicle component; and
installing the module to the attachment arrangement.

9. The method of claim 8, wherein driving the clip toward the vehicle component comprises tightening a bolt.

10. The method of claim 9, further comprising tightening the bolt to a specified drive torque.

11. The method of claim 8, further comprising installing an electrical interconnect through a connector receptacle defined by the attachment arrangement.

12. The method of claim 8, wherein a length of the clip along one axis is smaller than a diameter of the aperture.

13. The method of claim 8, wherein the module comprises an antenna module.

14. The method of claim 8, wherein the vehicle component comprises a vehicle panel.

15. The method of claim 14, wherein the vehicle panel comprises a vehicle roof panel.
